(19) United States
(12) Patent Application Publication
(10) Pub. No.: US 2003/0125963 A1
(43) Pub. Date: Jul. 3, 2003

(54) Wireless interactive rendezvous system for delivering goods and services

(75) Inventor: Jack E. Haken, Danbury, CT (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/029,832

(22) Filed: Dec. 27, 2001

(51) Int. Cl. G06F 17/60

(52) U.S. Cl. 705/1

(57) ABSTRACT

A method and system that coordinates time and position information, including the geographic position of a wireless device which is used to place an order, with route and delivery system information to allow dynamic rendezvous delivery of fast food, personal items or other goods and services to customers who are walking, driving or traveling. Rendezvous points between customers are calculated from one or more possible preparation locations taking into account cost metrics based on transportation modes and related constraints.

### BACKGROUND OF THE INVENTION

Fast food and other items and services are often ordered by mobile customers via cellular telephone, personal data assistant (pda) or other wireless data services, but delivery of the order must typically be made at a food stall, kiosk or other predetermined fixed location. Economies of costs and time can often be achieved if a less-constrained rendezvous point for delivery could be identified. Even greater savings can be achieved when the location and time of the rendezvous can be dynamically updated if external factors affect the travel of the customer and/or the delivery person.

Computer-based methods and apparatus for planning a multidimensional rendezvous based on multiple space-time constraints are described in U.S. Pat. No. 6,324,476, which is incorporated herein by reference.

Inexpensive portable location determining apparatus with horizontal resolution of a few meters, typically utilizing the Global Positioning System (GPS), are currently available in the consumer market. Government regulations in the United States will soon require an emergency location determining functionality with 50-meter accuracy (E911) in all cellular telephones. Centrally assisted systems that utilize GPS signals to provide location information are described in US patent RE 35498. Snaptrack Inc. of Campbell Calif. offers a similar thin client locator technology as a commercial product. Locator systems based upon triangulation of cellular telephone signals are also being currently marketed. It is also commonly known that the resolution of a GPS location system maybe further improved by utilization of map matching and dead reckoning techniques.

### The Invention

The invention is a method and system that coordinates time and position information, including the geographic position of a wireless device which is used to place an order, with route and delivery system information to allow dynamic delivery of fast food, personal items or other goods and services to customers who are walking, driving or traveling.

As used herein and in the claims that follow, unless the context requires otherwise, the term “position” refers to a point in space and time while the term “location” refers to a point in space.

As an example of the invention, a group of office workers may decide to eat lunch in a park. Before they leave their office, they place their food order via a cellular telephone or a wireless pda that includes position-determining functionality (e.g. GPS, Snaptrack, other e911 service etc). In response to menu questions, they indicate that they would like dynamic delivery of the food on their way to the park, their expected departure and/or arrival time, their method of transportation, and their expected route from their office to the park. The order information is entered into a system server that also has access to databases that include: maps and other routing information, various locations where the food order can be prepared, estimates of expected preparation time for the food items ordered, location and availability of potential deliver persons, and information about other pending and anticipated orders. Using this information the server chooses a preparation location and delivery person and then calculates a candidate rendezvous position where the customers and the delivery person can meet to effect delivery of the food. The server transmits this information to the customer's pda. The customers can either confirm or the candidate position or make proposals for modifications thereof.

Once the order has been confirmed, the server uses position information from the customer's pda, order status information from the preparation location and position tracking information from a pda or other locator module that is carried by the delivery person to monitor and, if necessary, dynamically update the rendezvous position. Messages can be sent in real time to enable the customers and delivery person to find and identify each other. If the order has been charged to a credit card or other account, the server can also send a confirming message to the customers' pda that verifies payment and authorizes the delivery person to turn-over the order to the customers.

Thus, principal features of a method in accordance with the invention are: receiving order data from a customer's wireless terminal that is collocated with the customer, which order data includes the type and quantity of items of goods and/or services ordered, the present position of the customer's wireless terminal, and one or more points along the customer's anticipated route of travel; identifying one or more supply locations from which the ordered items can be supplied; identifying one or more possible delivers for the ordered items; determining rendezvous criteria for the customer and each identified deliverer from each identified delivery location; calculating candidate rendezvous positions which satisfy the determined criteria; and sending information proposing delivery rendezvous positions to the customer's wireless terminal.

In further embodiments of the invention a server computer may also calculate one or more proposed routes for the customer to each proposed rendezvous position and may use travel method and constraint information in such calculation.

When a customer authorizes a delivery, the server computer may also dispatch a selected deliverer to deliver the items from a selected supply location to the selected one rendezvous position; and calculate a route for the deliverer to follow from the selected delivery position to the selected rendezvous position.

In a further preferred embodiment the server computer may receive from the customer' wireless data terminal and from a deliverer's wireless data terminal which is collocated with the deliverer, data with indicates their respective actual positions enroute to an intended rendezvous position and recalculate an updated rendezvous position based upon the actual positions of the customer and the deliverer.

The invention also includes a server computer that is programmed to implement the previously described method steps and a wireless data terminal for use by a customer when making use of the methods.

### THE DRAWINGS

The invention will be described with reference to the drawings, in which:

FIG. 1 illustrates a typical delivery scenario;

FIG. 2 is a flow diagram of information processing in the server computer; and

FIGS. 3 and 4 show candidate routes and rendezvous positions.

### DESCRIPTION OF A PREFERRED EMBODIMENT

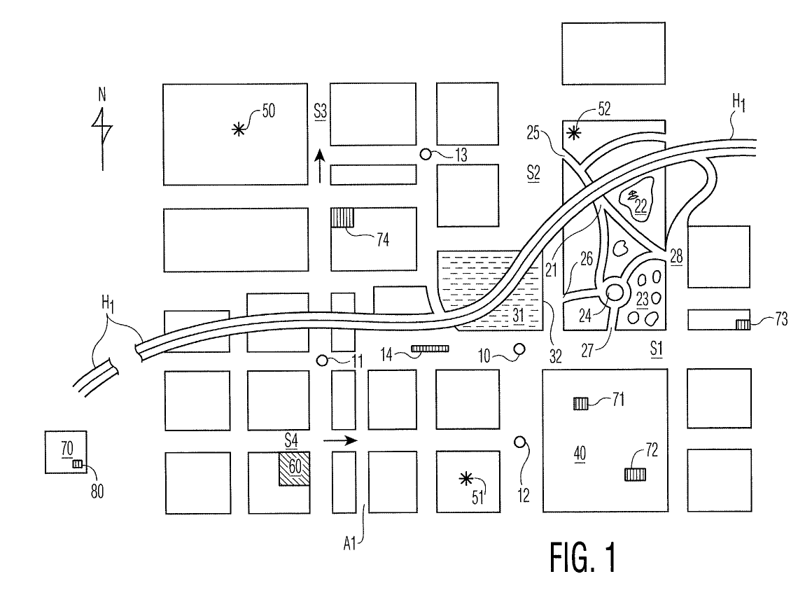

FIG. 1 is a map that illustrates a typical delivery scenario in accordance with the invention that takes place in an urban setting. The setting includes blocks of buildings separated by streets S1, S2, . . . and a limited access highway H1. Some of the streets (S3, S4) are limited to one-way traffic. Vehicular and pedestrian traffic at selected street intersections is controlled by traffic signals 10, 11, 12 and 13. Pedestrian traffic across street S1 is further blocked at central intersections by a barrier 14. Alley A1 is open to pedestrian and bicycle traffic, but is closed to motor vehicles.

A park 20 is bisected by highway H1 and includes walking paths 21, a lake 22, a forest 23, and a fountain 24. Bicycle access to the park from surrounding streets is only permitted through gates 25-28, but pedestrians may enter anywhere along the park perimeter. A car parking lot 31, with vehicle entrance 32 is located next to the west side of the park. An enclosed shopping mall 40 is located to the south of the park.

The area illustrated in the map is served by a two-way, cellular voice and data system with wireless handset location capability. Cell antennas are deployed at locations 50, 51 and 52.

A customer's office 60 is located in a building in the southwest quadrant of the map. A food delivery service company has a central service facility 70, located outside of the city center to the west, and a number of smaller facilities 71, 72, 73 and 74 at locations within the central mapped area.

The food company has a server computer 80 located in or accessible from its central facility 70. The computer server is linked by radio or telephone connections to slave computers and/or terminals at each of the smaller facilities from which it receives regular reports of data which indicate the types and quantity of food which are and will be available at the central and smaller facilities, the time required to prepare items of the available the food and the status of any food orders queued for delivery. This information is maintained in a database on the server.

The food company utilizes a number of delivery persons, who may be dedicated employees of the service, or independent contractors. Some of the independent contractors may provide delivery services on a shared basis, for example: the delivery company may utilize off-duty police officers as delivery persons or taxi drivers at times when they are not carrying regular passengers. Each delivery person carries or otherwise has in his vicinity a wireless mobile data device that is programmed to regularly report to the server the location of the delivery person and his status (that is: whether he is engaged in a delivery, free to make a delivery, and/or otherwise occupied). The delivery person will typically manually enter changes in status into the data device. The current location of each delivery person, his status and his mode of transportation are maintained in a database on the server. The database may also maintain information about any special constraints that affect a particular delivery person. For example, a delivery person who is wearing a uniform or other type of dress may not be permitted in some buildings or an armed delivery person may be excluded from some public buildings and transportation facilities.

The server also maintains a third database which includes map data of the delivery area and information defining obstacles to the movement of customers and delivery persons that is used to calculate proposed rendezvous positions as described below. As recognized by the abovementioned U.S. Pat. No. 6,324,476, these obstacles may be used to define a unique configuration space for each actor (i.e., for each customer and delivery person). Thus a delivery person traveling by automobile could be constrained to move along a route that principally utilizes streets, highways and parking lots, subject to various traffic restrictions. Alternately, a bicycle delivery person could be restrained to routes along regular streets, alleys and park gates and paths, but excluded from travel through shopping malls and woods. Likewise, a delivery person traveling on foot can move freely through most malls and woods, but would not usually travel across a lake or along a highway. Obstacles may be time dependent. For example, park gates and shopping malls may close at certain hours, traffic and parking rules may be time limited, and certain streets may be judged to be unsafe at various times of the day. Travel across a frozen lake might be considered acceptable in the coldest part of the winter. The database may also include information that estimates the speed that each actor is likely to achieve when moving in various portions of a route.

Certain locations that do not represent obstacles to travel may nonetheless be unsuitable for a delivery rendezvous. For example, food could not generally be delivered in the middle of a street with traffic. The customer or the delivery service might not wish to conclude a food delivery near a trash dump, public bathroom, or a competitor's restaurant, or a financial service transaction in an unsafe neighborhood. Likewise, certain locations may be preferred for a rendezvous. Delivery from a vehicle may be most effectively concluded in a parking lot and a sheltered, indoor delivery location maybe preferred on rainy days. Relevant information can be stored in the third database and used in conjunction with a cost metric to calculate candidate rendezvous times and locations.

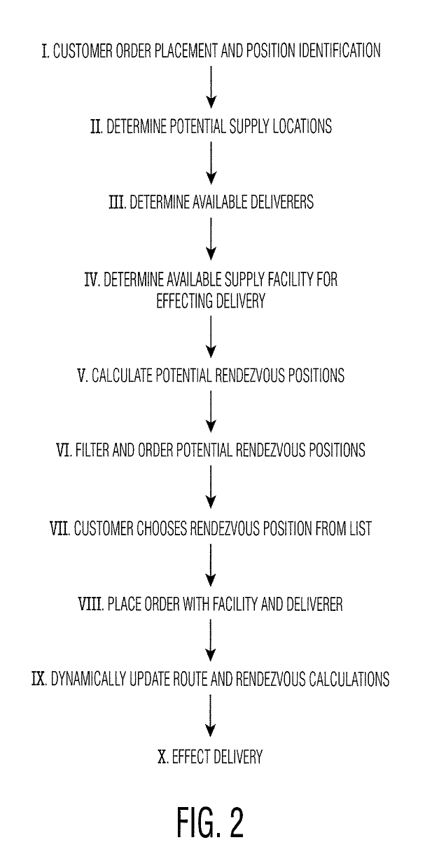

FIG. 2 is a flow chart that illustrates a typical transaction.

At step I, a customer in office 60 uses a wireless data terminal to place an order for food with the food company. The customer's terminal exchanges messages with the server and displays a series of questions or menus through which the customer indicates his choice of food items, a time or range of times when he would prefer to have the items delivered to him and his travel plans around the delivery time or times. For example, at 11:45 am the customer might indicate that he desired delivery of a chicken sandwich anytime before 12:30 pm and that he plans to remain at his present location until 12:00 noon and then travel by walking to the fountain 24 in park 20.

At step II, in response to the order the server 80 checks its database to determine whether the item ordered could be available in the desired time frame, before 12:30, at each of its facilities (70-74). This determination could include checking whether the required ingredients for the sandwich are or will be available at the facility and the length of any queue of orders waiting to be filled at the facility. At step II, the server also checks whether one or more deliverpersons are available to make a delivery from each facility during the relevant time frame. For this purpose, each delivery person may carry or remain close to a wireless terminal that regularly transmits their location and status to the server. On the basis of information determined in steps II and III, the server makes a list, Step IV, of potential facilities from which delivery can be effected. For example, The server might determine that the sandwich could be prepared either at facility 80, where a taxi driver would be available to make a delivery starting at 12:20; at facility 74, where a bicycle delivery person could be available to make a delivery anytime after 12:00; at facility 73, where a pedestrian delivery person could be available at 12:25 or at facility 71, where the food could be prepared by 12:15 but no delivery person could be available before 12:30.

At step V, the server applies the rendezvous calculation methods and algorithms, for example as taught in U.S. Pat. No. 6,324,476, to determine potential positions for a delivery using map and obstacle information corresponding to the map of FIG. 1 and separate cost metrics for the customer and each potential delivery person. For example, the cost metric for the taxi driver could in part correspond to the distance/time based tariffs used for taxi meter charges and would constrain the delivery route to legal movements along streets, highways and parking lots while the cost metrics for bicycle and foot delivery could be primarily based on time spent enroute. The customer's cost metric might be biased to minimize distance traveled and/or to avoid unsafe or congested streets.

At step VI, the food company may consider some potential rendezvous times or locations to be undesirable, more desirable or less desirable for deliveries. For example, the company may decide to exclude all deliveries in or along busy streets, near public restrooms and adjacent competitors business establishments. Deliveries from taxis may be less expensive and thus more desirable if they are made form parking lots. These and similar criteria can be used to generate an ordered list of candidate rendezvous positions from those that were identified during step V.

At step VII the list of candidate rendezvous positions is transmitted to the customer's terminal. The customer chooses a one of the positions from the list for delivery and transmits a confirmation message to the server. The confirmation message may include authorization to charge the customer's account or credit card for the items and delivery service provided.

At step VIII, the server places the order with the relevant facility and delivery person to initiate preparation and delivery of the food. The order to the delivery person will generally include specification of a particular route from the preparation facility to the selected rendezvous position that was determined during the rendezvous calculation step. The server may also transmit to the customer a suggestion that the customer follow a calculated route to the rendezvous.

At step IX, the server regularly polls the facility selected for preparing the food, the customer's terminal and the delivery person's terminal to monitor the status of the order and the locations of the customer and delivery person. If the customer or delivery person deviate from their expected routes, or from their expected progress along the expected routes, the server calculates a new expected delivery time and advises transmits messages to advise the customer and delivery person. If necessary the server can calculate a new rendezvous location based on the progress of the actors.

At step X, The customer and delivery person meet at the rendezvous site and delivery is made. If the customer and delivery person are both at the same location, but are for some reason unable to identify each other, the server may assist identification by sending further messages to their respective terminals. For example, simply causing a tone to be emitted from his terminal upon request by the delivery person may effect identification of a customer. In a preferred embodiment the server also transmits a coded message to the customer's terminal which the customer can show to delivery person to confirm his identity before the food is turned over. The delivery person transmits a message that informs the server that the transaction has been completed and the server updates its databases accordingly.

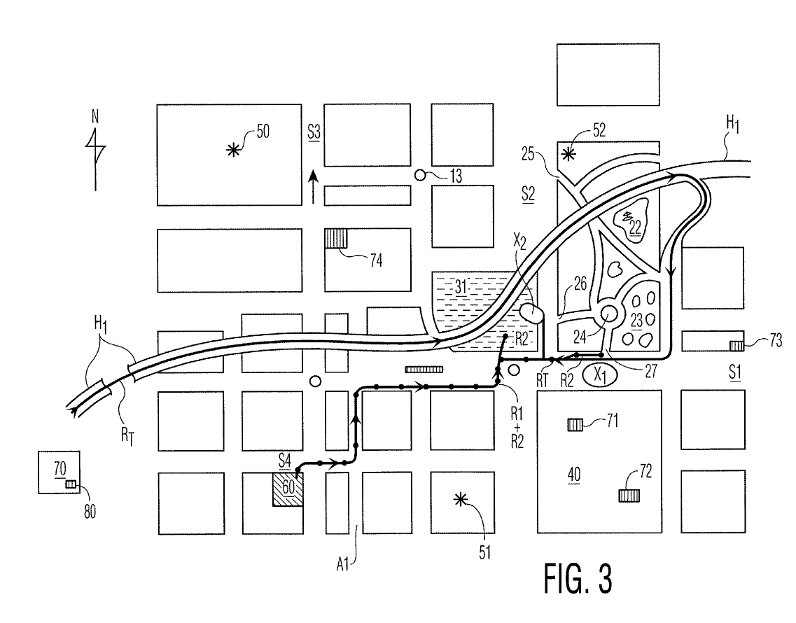

FIG. 3 is a map corresponding to FIG. 1 that is overlaid to show an example of routes and possible rendezvous locations between a customer who leaves building 60 at noon and a delivery person who leaves location 70 traveling by taxi at 12:20 pm. The taxi follows route R_{T} along the highway H1 and then onto street S1. The customer may take alternate routes R₁ or R₂ respectively along street S1 to two potential rendezvous positions: X₁ on the street outside of park gate 27 at 12:27 pm and X₂ in parking lot 31 at 12:30. The server maybe programmed to favor the second rendezvous location X₂ because a parking lot rendezvous is considered to be less costly than is a curbside rendezvous on a busy street.

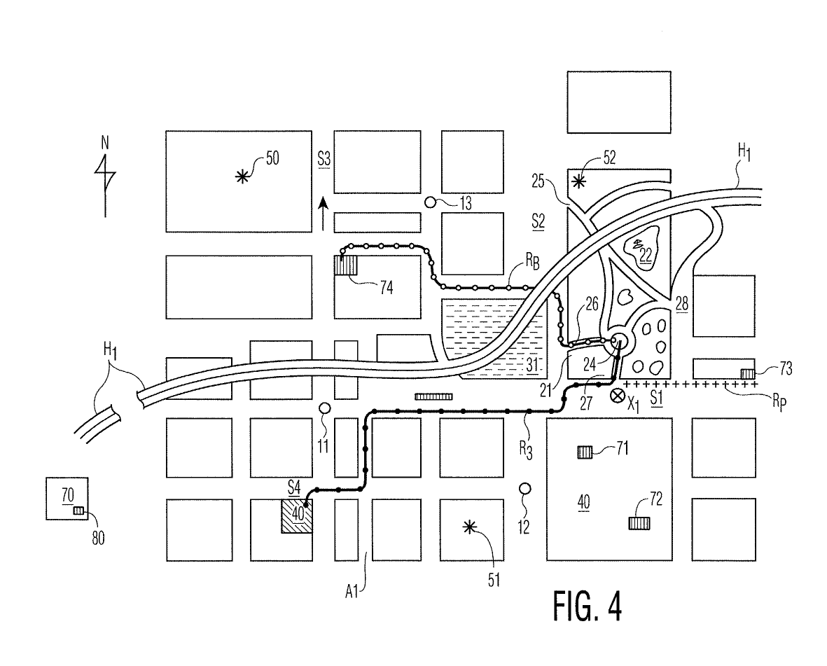

FIG. 4 is the map of FIG. 1 corresponding to FIG. 1 that is overlaid to show an example of routes and possible rendezvous locations between a customer who leaves building 60 at noon with a bicycle delivery person who leaves location 74 at noon and with a pedestrian delivery person who leaves location 73 at 12:25. The bicycle delivery person follows route R_{B} to gate 26 and thence along park paths 21 to a 12:10 rendezvous at fountain 24. The pedestrian delivery person follows route R_{P} along street S1, but is only able to reach a candidate rendezvous location at gate 27 by the 12:30 time limit. In both cases the customer follows route R₃ along street S1.

Finally, the server also determines that a vestigial rendezvous would be possible if the customer picked the food item up himself, without delivery, after 12:15 at location 71 in the mall 40 and then walks to the park.

In a further preferred embodiment, the server may store customer preference information in a database that can be used to modify cost metrics or to eliminate potential rendezvous sites from the list. Customer preference information may be collected by gathering information from previous orders of the same or statistically related customers, or may be directly entered into the database by the customer. Preference information could, for example include lists of favorite delivery persons, typical walking speed or travel times between various points, preferred routes, or a preference not to pickup food at fixed locations.

1. A method for delivering items to a mobile customer comprising:
receiving order data from a customer's collocated wireless terminal, which order data includes identification of the type and quantity of goods and/or services ordered, the present position of the customer's wireless terminal, and one or more positions on the customer's anticipated route of travel;
identifying one or more possible supply locations from which the ordered items can be supplied;
identifying one or more possible deliverers for the ordered items from said possible locations;
determining rendezvous criteria for the customer and each identified deliverer from each identified delivery location;
calculating candidate rendezvous positions which satisfy the determined criteria; and
sending information proposing delivery rendezvous positions to the customer's wireless terminal.

2. The method of claim 1 wherein the order data includes desired delivery time information.

3. The method of claim 1 further comprising the step of calculating one or more proposed routes for the customer to each proposed rendezvous position.

4. The method of claim 3 wherein the order data includes customer travel method and travel constraint information and wherein the step of calculating the proposed routes incorporates the travel method and constraint information.

5. The method of claim 1 further comprising the steps of:
receiving from the customer's wireless terminal authorization to deliver the items at a selected one of the proposed rendezvous positions;
dispatching a selected deliverer to deliver the items from a selected supply position to the selected one rendezvous position; and
calculating a route for the deliverer to follow from the selected delivery position to the selected rendezvous position.

6. The method of claim 5 further comprising the steps of receiving from the customer' wireless data terminal and from a deliverer's wireless data terminal which is collocated with the deliverer, data with indicates their respective actual positions enroute to an intended rendezvous position;
recalculating an updated delivery rendezvous position based upon the actual positions of the customer and the deliverer;
informing the customer and deliverer of the updated delivery position.

7. The method of claim 6 further comprising the step of transmitting to customer's wireless data terminal and to the deliverer's wireless data terminal route information to the updated delivery position.

8. A server computer programmed to implement the method of claim 6.

9. A customer's wireless data terminal programmed to implement the methods of claim 6.

10. The method of claim 5 further comprising the step of transmitting a customer identity-confirming message to the customer's wireless data terminal.

11. A server computer programmed to implement the method of claim 1.

12. A customer's wireless data terminal programmed to implement the methods of claim 1.

13. Electrical signals transmitted on a cellular wireless communication system that are modulated with information to implement the sending and receiving steps of claim 1.
